(19) United States
(12) Patent Application Publication
(10) Pub. No.: US 2011/0122417 A1
(43) Pub. Date: May 26, 2011

(54) Self-Referenced Optical Fiber Sensor with Stimulated Brillouin Scattering

(75) Inventors: Stéphanie Molin, Draveil (FR); Daniel Dolfi, Orsay (FR); Jean-Pierre Huignard, Paris (FR); Jean-Paul Pocholle, La Norville (FR); Martine Doisy, Plascassier (FR)

(73) Assignee: THALES, Neuilly-sur-Seine (FR)

(21) Appl. No.: 13/055,685

(22) PCT Filed: Jun. 25, 2009
(86) PCT No.: PCT/EP2009/057948

§ 371 Date: Jan. 24, 2011

(30) Foreign Application Priority Data
Jul. 25, 2008 (FR) 0804253

(51) Int. Cl. G01B 9/02

(52) U.S. Cl. 356/478

(57) ABSTRACT

A sensor is used to measure a physical quantity and includes at least: a measurement optical fiber including at least one Bragg grating; optical means designed to inject, into the fiber, a first, “pump” wave at a first optical frequency and a second, “probe” wave at a second optical frequency, the second optical frequency being different from the first optical frequency, the Bragg grating being designed to reflect the first and second optical waves, and the optical power of the first wave being sufficient to give, after interaction with the second wave reflected by stimulated Brillouin scattering, a “Stokes” wave, the frequency of which is representative of the physical quantity to be measured; and means for analyzing the difference in frequency between the two, “pump” and “Stokes”, optical waves. The sensor may notably be used as a hydrophone.

The field of the invention is that of optical fiber sensors for measuring physical quantities. Sensors based on optical fibers have been studied for almost thirty years. On this subject, the reader may refer, for example, to the publication by C. Menadier, C. Kissenger and H. Adkins entitled “The photonic sensor”, Instrum. Control Syst. Vol. 40, 114 (1967). They benefit from the advantages of optical fibers which, in addition to their low weight, compact size, low cost and insensitivity to electromagnetic interference, have low loss, have a high bandwidth and are suitable for multiplexing techniques and for the use of distributed amplifiers or sensors.

The applications of fiber-optic sensors are diverse: mention may be made of the publication by B. Culshaw entitled “Optical fiber sensor technologies: opportunities and—perhaps—pitfalls”, J. Light. Tech. Vol. 22, No. 1, 39 (2004). The most frequent applications relate to strain, temperature and pressure detection, but there are also applications in the field of detecting current/voltage, displacement, torsion, acceleration, gases, etc. The techniques employed are very varied, the ones most actively studied relating to:
interferometric methods (see P. Nash, “Review of interferometric optical fiber hydrophone technology”, IEE Proc. Radar Sonar Navig. Vol. 143, No. 3 (1996)), in particular:
   fiber gyros (see, on this subject, V. Vali and R. W. Shorthill, “Fiber ring interferometer”, Appl. Opt. Vol. 15, No. 5, 1099 (1976));
backscattering techniques such as Raman, Brillouin or Rayleigh scattering. The reader may refer, in particular, to L. Thevenaz et al., “Monitoring of large structures using distributed Brillouin fiber sensing”, Proceedings of the 13^{th} International Conference on optical fiber sensors (OFS-13), Korea, SPIE Vol. 3746, 345 (1999).

Almost half of the fiber sensors currently studied employ Bragg gratings (S. W. James et al., “Simultaneous independent temperature and strain measurement using in-fiber Bragg grating sensors”, Elect. Lett. 32 (12) 1133 (1996)). In particular, the use of laser active sensors based on Bragg gratings is becoming widespread. These include DBR (Distributed Bragg Reflector) lasers (see D. Kersey et al., “Fiber Grating Sensors”, J. Light Techn. Vol. 15, No. 8 (1997)) or DFB (Distributed FeedBack) lasers (see J. Hill et al., “DFB fiber-laser sensor developments”, OFS-17 Proc. SPIE Vol. 5855 p. 904 and U.S. Pat. No. 8,844,927 entitled “Optical Fiber Distributed FeedBack Laser” (1998)). The spectral purity of these lasers enables a substantial increase in sensitivity to be achieved compared with passive Bragg grating devices.

In the case of fiber Bragg grating hydrophones, the quantity to be measured is a strain applied to the sensor. The required sensitivity is such that, whatever the type of fiber grating used (DBR, DFB, passive Bragg), the interrogation system is complex. This is because the strain on the sensor induces a phase shift on the optical wave which propagates therein. To measure this phase shift requires comparing the phase of the signal in question with a reference signal. Among the methods used, two technical solutions may chiefly be distinguished for obtaining a reference wave. The first solution consists in using a reference wave coming from a second sensor similar to the first but isolated from interference. This method is described in the article by C. Sun et al., “Serially multiplexed dual-point fiber-optic acoustic emission sensor”, J. Light Techn. Vol. 22, No. 2 (2004). The second solution consists in splitting the signal of interest into two arms of very different optical paths and in making these two arms interfere with each other. In this case, the reference wave is a retarded copy of the signal wave. The reader may refer to the publication by S. Abad et al., “Interrogation of wavelength multiplexed fiber Bragg gratings using spectral filtering and amplitude-to-phase optical conversion”, J. of Light. Techn. Vol. 21, No. 1 (2003) for all information about this second method.

The use of active sensors emitting two optical waves of different frequencies is one conceivable solution for dispensing with interferometer setups or with additional sensors. DFB-FLs (Distributed FeedBack Fiber Lasers) oscillating on two polarization states or two propagation modes, whether transverse or longitudinal, have already formed the subject of patents and publications. Mention may be made of the following patents: U.S. Pat. No. 5,844,927 from Optoplan (Norway) 1998 “Optical fiber DFB laser”; U.S. Pat. No. 6,885,784 from Vetco Gray Controls Ltd (UK) 2005 “Anisotropic DFB fiber laser sensor”; and U.S. Pat. No. 6,630,658 from ABB Research Ltd (Switzerland) 2003 “Fiber laser pressure sensor” and the publication by Kumar et al., “Studies on a few-mode fiber-optic strain sensor based on LP₀₁-LP₀₂ mode interference”, J. Light. Techn. Vol. 19, No. 3 (2001).

Starting from these principles, various laser DFB fiber hydrophone architectures have been proposed. Details of these will be found in the following publications: P. E. Bagnoli et al., “Development of an erbium-doped fibre laser as a deep-sea hydrophone”, J. of Optics A: Pure Appl. Opt. 8 (2006); D. J. Hill et al., “A fiber laser hydrophone array”, SPIE Conference on Fiber Optic Sensor Technology and Applications Vol. 3860, 55 (1999); and S. Foster et al., “Ultra thin fiber laser hydrophone research through government-industry collaboration” OFS 2005-2006.

One of the limitations of current fiber laser hydrophone systems is the influence of the static pressure on the laser operation. Under the pressure of the water, either the cavities no longer emit or their emission wavelengths are modified to the point of impairing the operation of the system. Specifically, the pressure of the water increases by around one bar for every ten meters in depth. These systems are intended to be used on seabeds at depths of around 100 to 400 meters. The static pressure modifies the length of the laser cavity and causes the emission wavelength to be shifted by several nanometers—about 3 nanometers at 400 meters in depth. In the case of wavelength-multiplexed architectures for example, the static pressure places a direct limit on the spacing between two wavelengths, and consequently reduces the maximum number of sensors that can be placed in series on a single fiber. There are several solutions for alleviating this problem: it is possible either to measure the static pressure, and then to take this into account in the data processing, or to compensate for said pressure. The first method is cumbersome and limits the sensitivity of the system, while the second method requires elaborate mechanical and piezoelectric devices. The proposed architectures therefore remain complicated.

The object of the invention is to employ what are called “self-referenced” active fiber sensors with Bragg gratings operating through stimulated Brillouin scattering. The term “self-referenced” sensor is understood to mean any sensor generating two measurement signals carrying the information to be measured. In the present case, the signals are two optical waves emitted at different optical frequencies. A differential measurement of the variations in frequencies of the two signals is representative of the information to be measured. Thus, the quantity to be measured is obtained directly by the beating between these two optical waves and no longer requires either an interferometer or a reference sensor. The architecture of optical fiber sensors is thus considerably simplified by eliminating the interferometric modules with which interrogation setups are conventionally equipped.

The devices according to the invention are preferably used to produce optical fiber hydrophones, but they may be advantageously used to measure diverse physical quantities in various technical fields. In particular, they may be used as strain sensors in the aeronautical field, where they serve as anemometric-barometric sensors. The information about the quantity to be measured, for example the strain on the sensor, is obtained via the beat frequency of the two waves output by the sensor.

More precisely, one subject of the invention is an optical fiber sensor for measuring a physical quantity comprising at least one measurement optical fiber having at least one Bragg grating and:
optical means designed to inject, into the fiber, a first, “pump” wave at a first optical frequency and a second, “probe” wave at a second optical frequency, the second optical frequency being different from the first optical frequency, the Bragg grating being designed to reflect the first and second optical waves, and the optical power of the first wave being sufficient to give, after interaction with the second wave reflected by stimulated Brillouin scattering, a “Stokes” wave, the frequency of which is representative of the physical quantity to be measured; and
means for analyzing the difference in frequency between the two, “pump” and “Stokes”, optical waves.

Advantageously, the difference in frequency between the first wave and the second wave is of the order of 10 GHz.

Preferably, the fiber is a fiber made of a chalcogenide-based glass or a fiber made of bismuth-doped silica.

Preferably, the sensor is a strain sensor, the physical quantity to be measured being a mechanical strain applied on the fiber and, more specifically, the sensor may be a hydrophone.

The invention also relates to an array of optical fiber sensors having at least one of the above features. All the sensors are then arranged in series on one and the same optical fiber and the array includes a wavelength demultiplexer placed between said fiber and the analysis means.

The invention will be better understood and other advantages will become apparent on reading the following description given by way of nonlimiting example and in conjunction with the appended figures in which:

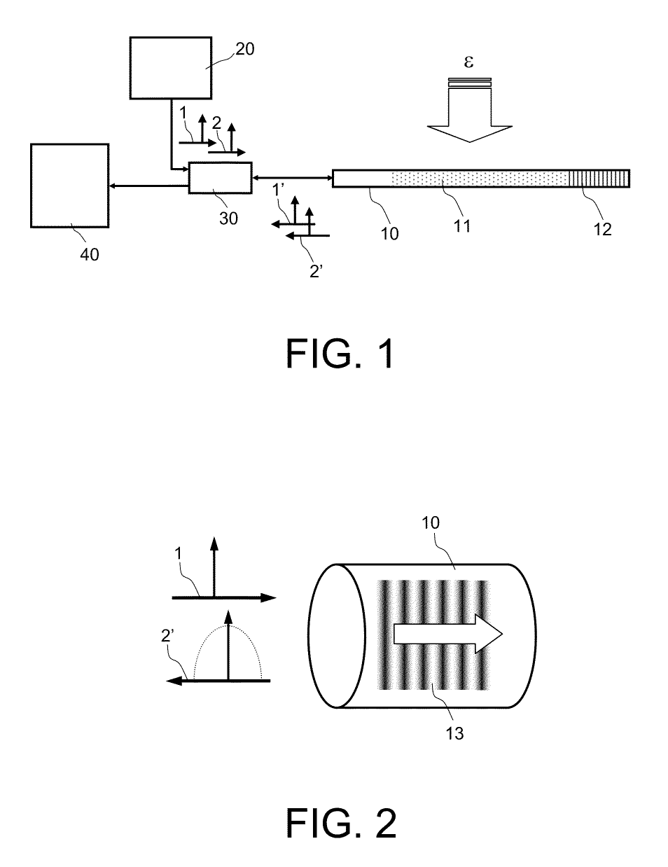

FIG. 1 shows the general setup of an optical fiber sensor according to the invention;

FIG. 2 shows the principle of stimulated Brillouin scattering;

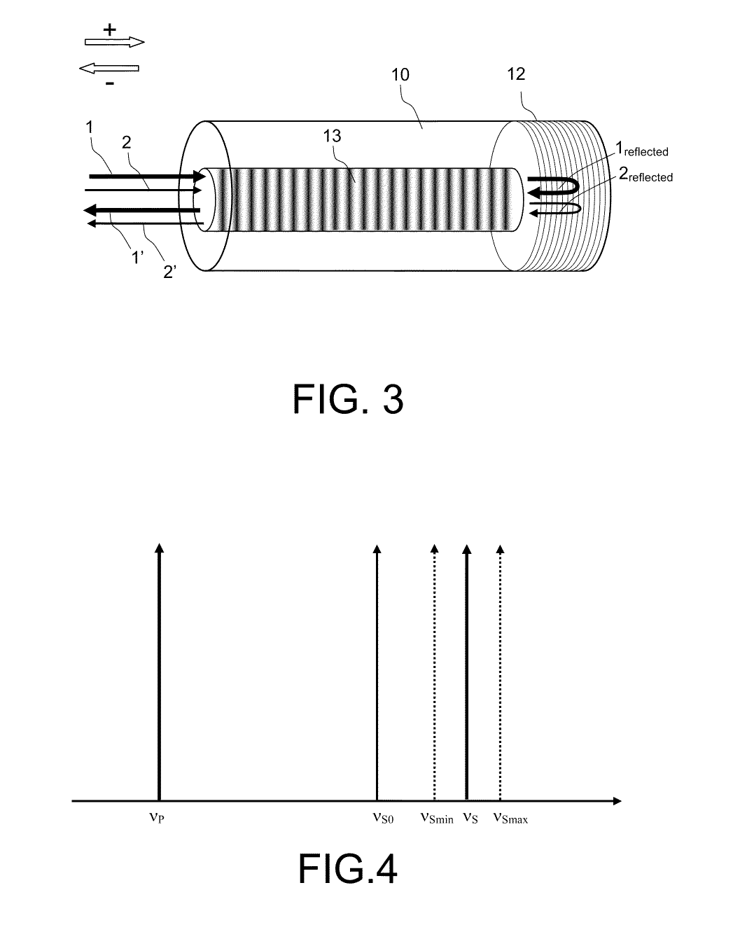

FIG. 3 shows one embodiment of an optical fiber sensor according to the invention;

FIG. 4 shows the various frequencies of the optical waves propagating in the optical fiber of the sensor; and finally

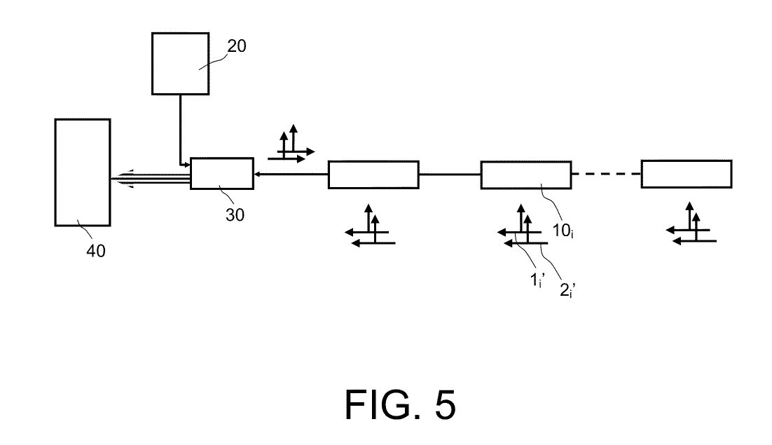

FIG. 5 shows an array of optical fiber sensors according to the invention.

A sensor according to the invention is shown schematically in FIG. 1. This sensor comprises:
an optical fiber 10 for measurement 11, the optical characteristics of which are sensitive to a physical quantity ε, the fiber having at least one Bragg grating 12;
optical means 20 designed to inject, into the fiber, a first, “pump” wave 1 at a first optical frequency denoted by ν_{P}(ε) and a second, “probe” wave 2 at a second optical frequency denoted by ν_{probe} (ε), the second optical frequency being different from the first optical frequency, the Bragg grating being designed to reflect the first and second optical waves, the optical power of the first wave being sufficient to give, after interaction with the second wave reflected by stimulated Brillouin scattering, a “Stokes” wave 2′, the frequency of which denoted by ν_{S}(ε) is representative of the physical quantity to be measured; and
the sensor includes means 30 for splitting the incident waves 1 and 2 and reflected waves 1′ and 2′ and means 40 for analyzing the difference in frequency between the two optical waves, the two waves being received by a photodetector (not shown in FIG. 1).

The core of the sensor according to the invention is an injected Brillouin fiber amplifier, shown in FIG. 2. A pump wave 1 injected into an optical fiber 10 is scattered by the acoustic phonons present in thermal equilibrium, that is to say spontaneous Brillouin scattering. When the optical power of the injected pump wave is greater than a threshold (dependent on the length of fiber, its composition and the source used), the beating between the pump wave and the backscattered wave 2′, called the Stokes wave, amplifies the acoustic wave—that is to say stimulated Brillouin scattering. Specifically, the beating of these waves creates a periodic variation in the intensity of the total electric field present in the medium. Associated with this periodic variation in the intensity of the electric field, via an electrostriction process, is a periodic variation in the refractive index of the medium represented by the grating 13. Since the two optical waves are assigned a different wavelength, the interference pattern to which they give rise moves in the medium. The variation in the refractive index of the medium is therefore periodic and moveable, and may be likened to a physical pressure wave. This acoustic wave is equivalent to a moveable Bragg mirror matched to the wavelength of the pump that has induced it.

Stimulated Brillouin scattering therefore writes, along the fiber, a dynamic index grating 13 which, unlike Bragg gratings photowritten by standard UV techniques, adapts to any slow variation in the environmental conditions of use of the sensor. The sensor is therefore intrinsically insensitive to static strains. In addition, two optical waves of different frequencies, called pump wave and Stokes wave, are output by this sensor. The information about the quantity to be measured, for example the strain applied to the sensor, is obtained via the variation in the beat frequency of the two waves output by the sensor. By using this self-referenced device it is possible to simplify the architecture of hydrophone systems, for example, by dispensing with the interferometric modules with which their interrogation setups are conventionally equipped. Such a device is also well suited to the production of microphones for measuring small variations in pressure undergone, for example, by aircraft wings due, for example, to local interference around a large static variation due to the altitude of the aircraft. Stimulated Brillouin scattering in optical fibers is a known effect and generally problematic for data transmission systems, but in the present case this scattering is perfectly suited to the production of sensors according to the invention.

To be able to use this device as a highly sensitive sensor, the optical waves that are output therefrom must have a high spectral purity. Thus, a Brillouin laser generating a spectrally very fine Stokes wave is the ideal device to be produced. The reader may refer on this subject to the following articles: S. Norcia, S. Tonda-Goldstein, R. Frey, D. Dolfi and J.-P. Huignard, “Efficient single-mode Brillouin fiber laser for low noise optical carrier reduction of microwave signals”, Opt. Lett. Vol. 28, No. 20 (2003) and S. Norcia, R. Frey, S. Tonda-Goldstein, D. Dolfi and J.-P. Huignard, “Efficient High-efficiency single-frequency Brillouin fiber laser with a tunable coupling coefficient”, J. Opt. Soc. Am. B 1 Vol. 21, No. 8 (2004).

There are a number of possible ways of exploiting the Brillouin effect. FIG. 3 shows one possible embodiment of a Brillouin amplifier with injection via a probe. This is used because a simple amplifier would generate a noisy Stokes wave with a spectral width of the order of 10 MHz, corresponding to the inverse of the acoustic phonon lifetime in a fiber. Such a width would be unacceptable for the abovementioned applications. To achieve spectral widths of the order of 1 kHz, the device has to be injected.

FIG. 3 shows a portion of an optical fiber closed at its end by the photowritten Bragg mirror 12 for the pump and Stokes waves, which may be broadband (the variation in Bragg wavelength with static strains is therefore not a problem). The component thus formed is injected via a pump wave 1 at around 1550 nm (νₚ, in the + direction) and a probe wave 2 (ν_{probe}, in the + direction), the wavelength of which is shifted with respect to the pump wave by the approximate Doppler frequency of the fiber used, i.e. about ν_{B}˜10 GHz. The interaction between the incident pump wave 1 (+ direction) and the probe wave 2_{reflected}, reflected by the Bragg mirror (in the − direction), gives rise, by stimulated Brillouin scattering in the core of the fiber, to a pure Stokes wave 2′ (in the − direction). The beating at frequency νₚ−νₛ between this Stokes wave (in the − direction) and the reflection 1_{reflected} or 1′ of the pump wave on the Bragg mirror (in the − direction) constitutes the signal of interest output by the sensor. The optical frequency νₚ of the pump wave is unchanged from that at which it was injected. The term νₛ denotes the beat frequency, equal to νₚ−νₛ.

The optical frequency νₛ of the Stokes wave depends, to the first order, on the nature of the fiber used and, to the second order, on its operating conditions. Consequently, νₛ must be adjusted once the device is in place, in order to maximize the power of the beat signal at the frequency ν_{B}. This frequency νₛ is a quantity that can be easily measured for each type of fiber, the magnitude of which is known: 11 GHz in the case of a standard fiber and 8 GHz in the case of a chalcogenide glass fiber. Once this adjustment has been made, the Bragg grating written by stimulated Brillouin scattering may be used as a sensor, for example a strain sensor. It has already been demonstrated in experiments that νₛ is a function of the strain. FIG. 4 shows the various frequencies of the sensor, namely ν_{P} the frequency of the pump wave, νₛ₀ the frequency of the initial probe wave, ν_{S} the frequency of the probe wave adapted to the type of fiber, and ν_{Smin} and ν_{Smax} the frequencies of the variation of the Stokes wave when the fiber is subjected to strain variations. The reader may refer on this subject to the article by M. Nicklès, L. Thévenaz and Ph. Robert, “Brillouin gain spectrum characterization in single-mode optical silica fibers”, JLT 15, p. 1842-1851 (1997).

This is a self-referenced device since two waves of different optical frequency are output therefrom, namely the reflection of the pump wave and the stimulated Stokes wave (shifted toward the long wavelengths of the Doppler frequency). The operation of this device is guaranteed whatever the static pressure applied thereto, since the Bragg grating created here adapts dynamically to the optical waves that write it through a nonlinear effect.

More precisely, the two emitted optical frequencies ν_{P}(ε) and ν_{S}(ε) cause beats on the detector at the frequency Δν(ε)=ν_{P}(ε)−ν_{S}(ε), which may also be written as Δν(ε)=ν_{P}−ν_{S}−δν(ε). The two optical frequencies ν_{P}(ε) and ν_{S}(ε) and the value Δν(ε) are functions of the longitudinal deformation ε experienced by the optical fiber of the sensor. Consequently, this deformation modulates the phase of the interference signal. Specifically, if E₁ and E₂ are the optical fields of the waves at the frequencies ν_{P} and ν_{S}, the photocurrent output from the detector is given by:

iₚₕ(t) [symbol] |E₁|²+|E₂|²+2|E₁∥E₂|cos [2π×Δν×t]

i.e. iₚₕ(t) [symbol] |E₁|²+|E₂|²+2|E₁∥E₂|cos [2πνₚt−2πν_{S}t+2πδνt].

The signal to be processed appears directly as a frequency modulation around a carrier at the frequency ν_{P}−ν_{S}. The two frequencies are typically spaced apart by ν_{P}−ν_{S} of the order of a few GHz to a few tens of GHz, thereby corresponding, in the near infrared, to a wavelength difference of the order of 0.16 nm. The phase modulation δν(ε) is obtained by heterodyne detection using a local oscillator of frequency close to ν₁-ν₂, making it possible to shift the signal toward the low frequencies, these being more suitable for digital processing. The local oscillator must be of sufficient spectral purity so as not to limit the measurement of the signal δν(ε) the amplitude of which may be of the order of 1 MHz. Currently available synthesizers have a stability of the order of 2×10⁻¹⁰/day, which is amply sufficient for this type of sensor.

The sensitivity of the sensors presented here is to be compared, for example, with the quantity of interest for hydrophone applications, namely the DSS0 (deep sea state zero). Thus, the smallest signal detectable by the sensor must correspond to a pressure noise spectral density of the order of P=150 μPa/\sqrt{Hz} at 1 kHz. The longitudinal deformation corresponding to an applied pressure of 150 μPa/\sqrt{Hz} on an optical fiber is obtained by the equation:

ε_{z}=(2θ−1)P/E,

where E is the Young's modulus and θ is the Poisson's ratio.

For silica, E=72×10⁹ Pa and θ=0.23, corresponding to a longitudinal deformation equal to ε_{z}=−0.75×10⁻¹⁵/\sqrt{Hz}.

The optical fiber sensors are inserted into specific mechanical devices allowing optimum transfer of the acoustic wave in terms of elongation of the cavity, causing a gain in elongation of the order of 40 dB, which is equivalent to a minimum pressure to be detected of the order of 1 Pa, and therefore equivalent to a longitudinal strain ε_{z}=−0.75×10⁻¹¹/\sqrt{Hz}. Consequently, for the sensors presented below, it is opportune to calculate the frequency shift of the laser waves emitted when the cavity is subjected to this representative longitudinal strain, namely ε_{z}=−0.75×10⁻¹¹/\sqrt{Hz}.

The device may be considered as a Bragg rating in an optical fiber. The shift δλ_{B} of the Bragg wavelength of Bragg grating sensors is typically:

$${δλ}_{B} = 2 {n}_{e} {Λɛ}_{z} - 2 {n}_{e} Λ [ \frac{{n}_{e}^{2}}{2} ( ( {p}_{11} + {p}_{12} ) {ɛ}_{r} + {p}_{12} {ɛ}_{z} ) ] \qquad ( E 1 )$$

where:
ε_{z} and εᵣ are the longitudinal and radial strains (εᵣ=ε_{z} in the isotropic case);
nₑ is the effective refractive index of the fiber;
Λ=λ_{B}/2nₑ is the period of the grating; and
p₁₁ and p₁₂ are the longitudinal and transverse elastic-optic coefficients which, for silica, are nₑ=1.456, p₁₁=0.121 and p₁₂=0.265.

The frequency shift of the Bragg grating fiber sensor due to a static longitudinal strain is deduced from this equation E1. This shift is approximately equal to δν₁≈0.78ε_{z}ν₁. The above equation is well confirmed experimentally.

Assuming that this equation remains valid in dynamic mode, the shift in the optical frequency emitted by a Bragg grating sensor emitting a wave of optical frequency ν₁, and subjected to a pressure equivalent to the deep sea state zero, is λ˜1.55 μm, i.e. ν₁≈192.10¹² Hz:

δν₁≈0.78×0.75×10⁻¹⁵×192×10¹²≈112 mHz/\sqrt{Hz}.

This corresponds, considering a mechanical amplification of around 40 dB, i.e. to a longitudinal dynamic strain to be measured of the order of 10⁻¹¹/\sqrt{Hz}), to δν₁≈1 kHz/\sqrt{Hz}.

The system for interrogating the sensor must be capable of measuring very small frequency shifts of the laser (of the order of 1 kHz/\sqrt{Hz} in the abovementioned case); it is therefore necessary to have a single-frequency laser with a very low noise in the useful (for example acoustic) frequency band of the sensor.

Certain types of fiber are particularly well suited to the sensors according to the invention. Thus, chalcogenized fibers have a Brillouin gain two orders of magnitude higher than standard silica fibers and an elastic-optic coefficient (strain sensitivity) twenty times higher than silica. The term “chalcogenized fiber” is understood to mean an optical fiber made of a glass containing a chemical compound comprising a chalcogenide, such as oxygen, sulfur, selenium, tellurium or polonium. Consequently, they are excellent candidates for producing stimulated Brillouin scattering sensors. Bismuth-doped silica fibers also make excellent sensors and additionally have a low absorption.

The multiplexing for discriminating the signals coming from the various sensors may be achieved using various techniques. For example, temporal multiplexing and spectral multiplexing may be mentioned.

The multiplexing of the device shown diagrammatically in FIG. 5 may be wavelength multiplexing, using Bragg mirrors with a Bragg wavelength spaced apart by a few nm from one sensor to the next. The interrogation source may be a frequency comb of the telecom source type. To multiplex several sensors i according to the invention, it is also necessary to add, to the device in FIG. 1, a probe laser 20 propagating in the same direction as the pump wave. This probe laser is either a broad source around 1.5 μm or a tunable source around 1.5 μm, matched to the Bragg wavelength of the cavity end mirrors. The sensors may be produced according to the embodiments described above. In this case, each sensor i comprises a fiber 10, that emits two waves 1ᵢ′ and 2ᵢ′ having the frequencies ν_{iP} and ν_{iS}.

1. An optical fiber sensor for measuring a physical quantity comprising at least one measurement optical fiber having at least one Bragg grating, and further comprising:
optical means designed to inject, into the fiber, a first, “pump” wave at a first optical frequency and a second, “probe” wave at a second optical frequency, the second optical frequency being different from the first optical frequency, the Bragg grating being designed to reflect the first and second optical waves, and the optical power of the first wave being sufficient to give, after interaction with the second wave reflected by stimulated Brillouin scattering, a “Stokes” wave, the frequency of which is representative of the physical quantity to be measured; and
means for analyzing the difference in frequency between the two, “pump” and “Stokes”, optical waves.

2. The optical fiber sensor as claimed in claim 1, wherein the difference in frequency between the first wave and the second wave is of the order of 10 GHz.

3. The optical fiber sensor as claimed in claim 1, wherein the optical fiber is a fiber made of a chalcogenide-based glass or an optical fiber made of bismuth-doped silica.

4. The optical fiber sensor as claimed in claim 1, wherein the sensor is a strain sensor, the physical quantity to be measured being a mechanical strain applied on the fiber.

5. The optical fiber sensor as claimed in claim 4, wherein the sensor is a hydrophone.

6. An array of optical fiber sensors as claimed in claim 1, wherein all the sensors are arranged in series on one and the same optical fiber and in that the array includes a wavelength multiplexer placed between said fiber and the analysis means.
